(19) United States
(12) Patent Application Publication
(10) Pub. No.: US 2024/0320359 A1
(43) Pub. Date: Sep. 26, 2024

(54) SYSTEM-ON-CHIP INCLUDING RESOURCE ISOLATION FRAMEWORK AND COUNTERMEASURE CIRCUIT, AND CORRESPONDING METHOD

(71) Applicant: STMicroelectronics International N.V., Geneva (CH)

(72) Inventor: Loic Pallardy, Rouillon (FR)

(21) Appl. No.: 18/614,171

(22) Filed: Mar. 22, 2024

(30) Foreign Application Priority Data
Mar. 24, 2023 (FR) 2302838

(51) Int. Cl. G06F 21/62; G06F 9/50

(52) U.S. Cl. CPC G06F 21/6218; G06F 9/5044

(57) ABSTRACT

A system-on-a-chip includes at least one slave resource, a resource isolation system, and a countermeasure circuit capable of and intended to limit the operation of the system against potential anomalies, and, for the at least one slave resource, a protection circuit configured to block or transmit transactions addressed to the resource depending on access rights of the resource and of the transaction. The protection circuit is configured to generate and directly communicate an alert signal to the countermeasure circuit in the event of a transaction being blocked.

### CROSS-REFERENCE TO RELATED APPLICATIONS

This application claims the benefit of French Patent Application No. 2302838, filed on Mar. 24, 2023, which application is hereby incorporated herein by reference.

### TECHNICAL FIELD

Implementations and embodiments relate to integrated circuits, in particular systems-on-a-chip, for example a microcontroller or a microprocessor, and corresponding methods, and more particularly to techniques for isolating resources belonging to the system-on-a-chip.

### BACKGROUND

In order to participate in guaranteeing the reliability of a system-on-a-chip, resource isolation techniques allow the access of one or more master devices to specific slave resources to be restricted. Access is described as “illegal” when a transaction, emitted by a master device towards a slave resource, is not compliant with the established access restrictions.

For example, the publication FR 3103586 A1 (28 May 2021) describes a technique for managing these access restrictions that is simple to set up and to implement, in particular when this management is dynamic, i.e. when it depends on different applications of the system-on-a-chip.

In conventional resource isolation techniques, typically only a “trusted domain,” implemented in software form, in particular to manage restrictions and access rights, is informed of a resource being accessed illegally, by a mechanism for managing illegal access.

Moreover, countermeasures can typically be provided to limit the operation of the system-on-a-chip against potential anomalies, for example by restricting access to some or all of the resources to only a secure and trusted environment. Anomalies can correspond to a violation of the resource isolation rules, which could be caused by an attack aimed at recovering sensitive or secret data, and as part of a reverse engineering process.

However, the trusted domain is responsible for generating an alert signal controlling the operation of the countermeasures if illegal access is identified as an anomaly or as a potential attack.

During the decision software processing operation implemented in order to generate the alert signal, secret data are not blocked for several clock cycles. Moreover, an accumulation of trusted domain interrupts caused by multiple illegal accesses could create a denial of service for the trusted domain, and delay the software processing operation.

There is thus a need to improve the mechanisms for protecting against illegal access, in particular in terms of implementing countermeasures and actions.

In this respect, embodiments and implementations provide for directly generating the alert signal controlling the countermeasures, from the resource accessed illegally, without firstly carrying out the software-based decision processing operation.

Moreover, embodiments and implementations provide for being able to select the behavior for each resource in order to decide whether an illegal access should be silent or result in the generation of the alert signal.

### SUMMARY

According to one aspect, a system-on-a-chip includes at least one slave resource, a resource isolation system, and a countermeasure circuit capable of and intended to limit the operation of the system against potential anomalies, and, for the at least one slave resource, a protection circuit configured to block or transmit transactions addressed to the resource depending on access rights of the resource and of the transaction, the protection circuit being configured to generate and directly communicate an alert signal to the countermeasure circuit in the event of a transaction being blocked.

The system-on-a-chip can typically include at least one master device capable of generating the transactions addressed to the resource, for example via an interconnection bus.

It should be noted in particular that it is the protection circuit associated with its respective resource (sometimes also referred to as a “firewall”) that is responsible for generating the alert signal. The command for the action taken by the countermeasure circuit is thus directly communicated, which improves the responsiveness and reliability of the countermeasure mechanism.

According to one embodiment, the system-on-a-chip includes an alert channel directly connecting the protection circuit to the countermeasure circuit and dedicated to transmitting the alert signal.

In other words, the alert signal can be communicated directly, without any intermediary, via the alert channel, and since it is not subject to a software process, reliability is improved.

According to one embodiment, the system-on-a-chip includes a plurality of the at least one resource, and a multiplexing element configured to group all of the alert channels connected to the respective protection circuits into a single outgoing alert channel directly connected to the countermeasure circuit.

For example, the multiplexing element has an “OR gate”-type function for transmitting alert signals, irrespective of their origin.

According to one embodiment, the resource isolation system includes, in a set of configuration registers, for each resource, a location for containing an alert parameterization datum, the protection circuit of each resource being configured to generate, or not, the alert signal in the case of a transaction addressed to the resource being blocked, according to the alert parameterization datum for this resource.

In this way, actuation of the action taken by the countermeasure circuit can be activated or deactivated depending on each resource. More specifically, a resource may or may not be considered critical, depending on how the system-on-a-chip is used. Activation of the alert signal if a transaction for a given resource is blocked may or may not be desired.

According to one embodiment, the system-on-a-chip further includes at least one master device capable of generating the transactions addressed to the resource, the transactions comprising a master identification datum, and the resource isolation system includes, in a set of configuration registers, for each master device, a location for containing a second alert parameterization datum, the protection circuit of each resource being configured to generate, or not, the alert signal in the case of a transaction addressed to the resource by the master device being blocked, according to the second alert parameterization datum for this master device.

In this way, actuation of the action taken by the countermeasure circuit can be activated or deactivated depending on each master device. More specifically, a trusted environment, for example the implementation of firmware on a “trusted” master device, could be considered unable to generate an illegal access. The detection of illegal access from such an environment can therefore be systematically treated as an attack by the countermeasure circuit.

According to another aspect, a method is described for managing the resource isolation of a system-on-a-chip, wherein the system-on-a-chip comprises at least one slave resource, a resource isolation system, and a countermeasure circuit capable of and intended to limit the operation of the system against potential anomalies, and the method comprises, for each resource, implementing a protection comprising blocking or transmitting transactions addressed to the resource, depending on access rights of the resource and of the transaction, and generating an alert signal directly communicated to the countermeasure circuit in the event of a transaction being blocked.

According to one implementation, the alert signal is transmitted on a dedicated alert channel, directly connecting the protection circuit to the countermeasure circuit.

According to one implementation, the system-on-a-chip includes a plurality of the at least one resource, and all of the alert channels connected to the respective protection circuits are grouped into a single outgoing alert channel directly connected to the countermeasure circuit.

According to one implementation, an alert parameterization datum, for each resource, is contained in a set of configuration registers, and the alert signal is generated, or not in the case of a transaction addressed to a resource being blocked, according to the alert parameterization datum for this resource.

According to one implementation, wherein the system-on-a-chip further includes at least one master device generating the transactions addressed to the resource comprising an identification datum for the master, a second alert parameterization datum, for each master device, is contained in a set of configuration registers, and the alert signal is generated or not in the case of a transaction addressed to a resource by the master device being blocked, according to the second alert parameterization datum for this master device.

### BRIEF DESCRIPTION OF THE DRAWINGS

Other advantages and features of the invention will become apparent upon examining the detailed description of non-limiting embodiments and implementations, and from the accompanying drawings, in which figures:

FIG. 1 illustrates an example embodiment of a system-on-a-chip;

FIG. 2 illustrates a method implemented by the protection circuit;

FIG. 3 illustrates an example configuration register; and

FIG. 4 illustrates an example implementation of a decision taken by a protection circuit in the event of a transaction being blocked.

### DETAILED DESCRIPTION OF ILLUSTRATIVE EMBODIMENTS

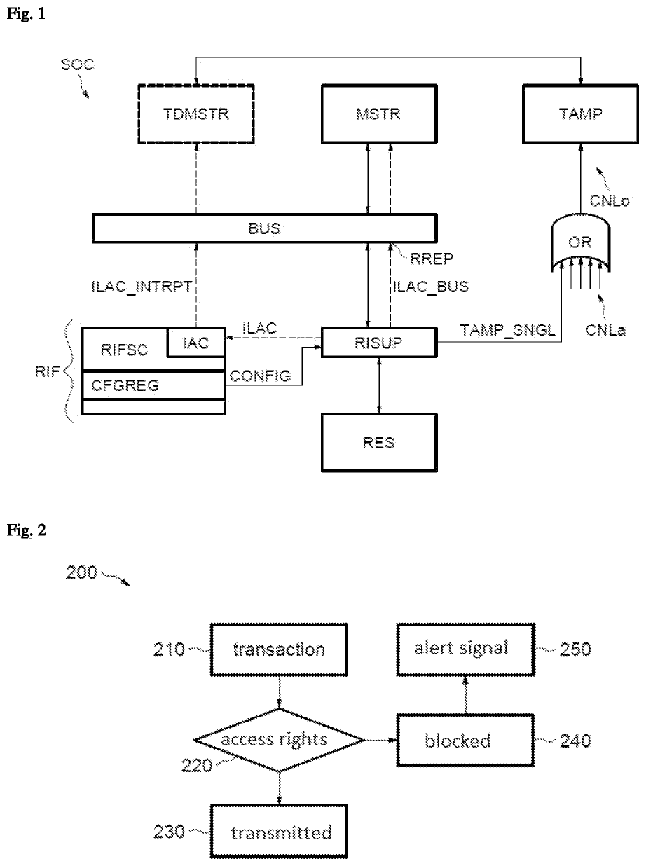

FIG. 1 diagrammatically illustrates an example embodiment of a system-on-a-chip SOC, such as a microcontroller or a microprocessor for example, including at least one master device MSTR, and at least one slave resource RES capable of communicating via an interconnection bus BUS.

For example, the master devices TDMSTR, MSTR can consist of processors or central processing units “CPU” adapted to implement software functions; or other master devices such as a direct memory access “DMA” controller.

In this example, the system-on-a-chip SOC further includes a so-called “trusted” master device TDMSTR, typically in charge of the configuration and management of access rights defining the isolation rules, set up by a resource isolation system RIF described in more detail hereinafter.

For example, the resources can comprise an I2C-type (standing for “Inter Integrated Circuit”), SPI-type (standing for “Serial Peripheral Interface”), UART-type (standing for “Universal Asynchronous Receiver Transmitter”), or real-time clock “RTC”-type peripheral, or a peripheral of the memory type such as an internal memory of the system-on-a-chip or an interface for a memory external to the system-on-a-chip.

The interconnection bus BUS is coupled between the master devices and the slave resources and allows transactions, for example write or read transactions, and more generally information, to be routed on channels possibly having dedicated functions, between the master devices MSTR and the slave resources RES.

For example, the interconnection bus can be an “AXI”-type, standing for “Advanced extensible Interface,” or “AHB”-type, standing for “Advanced High-performance Bus,” bus which are “AMBA,” standing for “Advanced Microcontroller Bus Architecture,” microcontroller bus types.

In one particular case, the interconnection bus BUS can include an error notification channel RREP, which is for example intended to be used by the slave resources to communicate information in response to a transaction.

The system-on-a-chip SOC further includes a resource isolation system RIF configured to restrict access of one or more master devices to specific slave resources, in particular according to access rights defined in this respect.

For example, the access rights that could be used to define the resource isolation rules could include defining privileged and non-privileged environments, and possibly cumulatively secure and non-secure environments, possibly as well as a compartmentalization identifier.

The concepts of privileged/non-privileged and secure/non-secure access rights and environments are well known to a person skilled in the art, and the notion of a compartmentalization identifier is taught in particular in the publication FR 3103586 A1 (28 May 2021).

Access is described as “illegal” when the access rights of a transaction are not compliant with those of the receiving resource.

For example, the resource isolation system RIF of the system-on-a-chip can be incorporated in the resource isolation technique described in the publication FR 3103586 A1 (28 May 2021).

In particular, the resource isolation system RIF includes, for each resource RES, a protection circuit RISUP (sometimes called a “firewall”), configured to block or transmit transactions addressed to the resource RES via the interconnection bus BUS, according to the access rights of the resource and of the transaction.

Moreover, the system-on-a-chip SOC includes a countermeasure circuit TAMP capable of and intended to limit the operation of the system-on-a-chip SOC against potential anomalies.

Anomalies can correspond to a violation of the resource isolation rules, which could be caused by an attack aimed at recovering sensitive or secret data, for example as part of a reverse engineering or hacking process.

For example, such a countermeasure circuit TAMP can be produced in the form of a hardware circuit that can, in one clock cycle, disconnect critical resources (which benefit from protection) from the rest of the system, either permanently or temporarily.

For example, the countermeasure circuit TAMP can be able to “freeze” the resource in the system, i.e. restrict all (or some) access to the protected resources only to a secure and trusted environment, i.e. for example only to the trusted master device TDMSTR, or even strictly prevent all access to the resources. The countermeasure circuit TAMP can also delete the contents of certain sensitive registers, and in this respect is capable of resetting the registers.

Depending on the resource to be protected, there are various ways of implementing this, including generating a “reset”-type signal, or isolating the resource by disconnecting it from the interconnection bus.

On the other hand, for example depending on a decision taken by the trusted master device TDMSTR, the countermeasure circuit TAMP can be configured to optionally relax the restriction, or carry out other actions to prevent the anomaly from persisting, for example deactivate an identified function, completely restart the system-on-a-chip, delete data stored in memory, or even destroy the system-on-a-chip SOC.

Furthermore, according to a general feature of the present description, the protection circuit RISUP is configured to generate and directly communicate an alert signal TAMP_SGNL to the countermeasure circuit TAMP in the event of a transaction being blocked. The alert signal TAMP_SGNL can, for example, be adapted to actuate an action by the countermeasure circuit TAMP, for example such as that presented above to freeze the system-on-a-chip SOC or to prevent the anomaly from persisting.

In this respect, reference is made to FIG. 2.

FIG. 2 illustrates the method 200 implemented by the protection circuit RISUP, in the management of the resource isolation system RIF of the system-on-a-chip SOC described with reference to FIG. 1.

Thus, the implementation of the protection 200 of each resource, comprises, upon reception 210 of a transaction originating from the interconnection bus BUS, a verification 220 of the access rights of this transaction with regards to the access rights of the resource.

Depending on the verification 220, the transaction 210 may be transmitted 230 to the resource RES downstream, or blocked 240 by the protection circuit RISUP upstream.

Moreover, if the transaction is blocked 240, the alert signal TAMP_SGNL is generated 250 by the protection circuit RISUP, and directly transmitted to the countermeasure circuit TAMP.

Reference is made again to FIG. 1.

The alert signal TAMP_SGNL is advantageously communicated via an alert channel CNLa connected directly between the protection circuit RISUP and the countermeasure circuit TAMP and dedicated to the transmission of the alert signal TAMP_SGNL.

In other words, the alert signal can be communicated directly, without any intermediary, via the alert channel, and since it is not subject to a software process, the reliability of the communication is improved.

The system-on-a-chip SOC usually includes a large number of resources RES, for example several tens of resources, and several of these resources RES (in absolute terms, all the resources) can benefit from direct communication of the alert signal TAMP_SGNL by the respective protection circuits RISUP.

Thus, a multiplexing element OR is configured to group all of the alert channels CNLa respectively connected to the respective protection circuits RISUP, into a single outgoing alert channel CNLo directly connected to the countermeasure circuit TAMP. For example, the multiplexing element has an “OR gate”-type function for transmitting alert signals, irrespective of their origin CNLa.

Moreover, advantageously, the alert channel CNLa is physically separate from the interconnection bus BUS on which the transactions addressed to the resource RES are communicated. Again, this enables the alert signal to be communicated directly and without any intermediary, in particular without using the protocol of the interconnection bus BUS, or addressing, etc., thus improving the responsiveness and reliability of the communication of the alert signal.

In parallel with the communication of the alert signal TAMP_SGNL described above, the resource isolation system RIF can also be configured to generate an interrupt signal ILAC_INTRPT addressed to the trusted master device TDMSTR, for example via the routing mechanism of the interconnection bus BUS, in the case of a transaction being blocked by any one of the protection circuits RISUP of the peripherals (at least one) of the system-on-a-chip SOC.

In this respect, the resource isolation system RIF may include a central unit for managing illegal access IAC, for example within a control device of the resource isolation system RIFSC.

In this case, the protection circuits RISUP of the resources RES are configured to generate a detection signal for an illegal access ILAC (and/or for the blockage of the corresponding transaction) and communicate it to the central unit for managing illegal access IAC.

In turn, the central unit for managing illegal access IAC is configured to generate the interrupt ILAC_INTRPT addressed to the trusted master device TDMSTR, in the case of an illegal access detection signal ILAC being received from any one of the protection circuits RISUP.

Moreover, the protection circuit RISUP can be capable of generating a notification signal ILAC_BUS addressed to the master device MSTR at the origin of the blocked transaction, via the bus routing mechanisms, and advantageously on an error notification channel RREP of the interconnection bus BUS.

It should be noted that the error notification channel RREP of the bus can normally be intended to be used by the resource RES, and not by the protection circuit RISUP itself, for example to communicate response information from the slave resources, following reception of a read or write transaction, such as an error notification in the event of a transaction being successfully received but not understood by the slave resource.

Thus, the error notification channel RREP of the bus is potentially “overloaded” since it is connected and can be used independently by two distinct circuits, both by the protection circuit RISUP and by the resource RES.

Moreover, the notification signal ILAC_BUS may be intended to generate a reaction, advantageously an immediate reaction, of the master device MSTR at the origin of the blocked transaction.

The reaction of the master device MSTR to receiving the notification signal ILAC_BUS may comprise interrupting the ongoing data transfer and/or stopping the ongoing process (at the origin of the illegal access) by forcing the generation of a data abort exception allowing the address having generated the illegal access to be identified.

Finally, the resource isolation system RIF may advantageously include configuration registers CFGREG, for example within the control device of the resource isolation system RIFSC, capable of containing configuration information CONFIG for the elements of the resource isolation system RIF (in particular the protection circuits RISUP of the resources RES and of the master devices MSTR, TDMSTR).

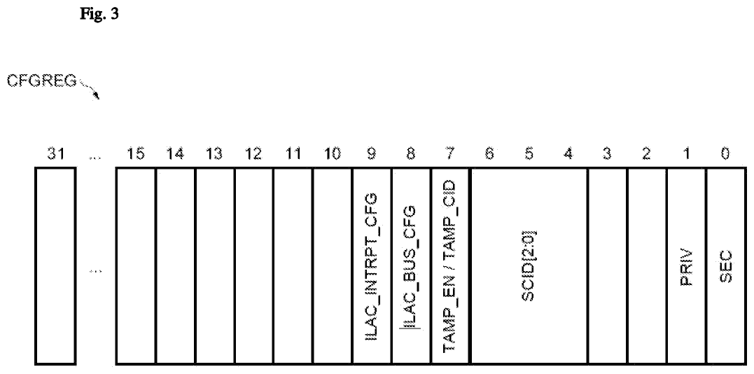

In this respect, reference is made to FIG. 3.

FIG. 3 illustrates an example of a configuration register CFGREG that is, for example, dedicated to a resource RES of the system-on-a-chip SOC.

The configuration register CFGREG contains 32 locations “o” to “31” for containing parameterization data relating to the isolation of the resources, for the respective resource RES.

For example and arbitrarily, the location “o” may be used to define the secure or non-secure access right SEC of the resource, whereas the location “1” may be used to define the privileged or non-privileged access right PRIV of the resource.

Also for example, the locations “4” to “6” may contain the compartmentalization identifier CID of the resource.

In an advantageous example embodiment of the resource isolation system RIF, the configuration register CFGREG of each resource RES includes a location “7” intended to contain an alert parameterization datum TAMP_EN.

The alert parameterization datum TAMP_EN is used to activate or deactivate (for example when set to “1” or “0” respectively) the function of generating and communicating the alert signal TAMP_SGNL directly to the countermeasure circuit TAMP, by the protection circuit RISUP which blocks a transaction.

For example, the value of the alert parameterization datum TAMP_EN can be stored by a user in order to select the degree of protection against illegal access the user wishes to benefit from for each resource RES of the system-on-a-chip SOC.

For example, the value of the alert parameterization datum TAMP_EN can also be stored through an access right set-up procedure, usually performed by the trusted master device TDMSTR upon start-up of the system-on-a-chip SOC.

Thus, the operation of the protection circuit RISUP of each resource RES is configured according to the alert parameterization datum TAMP_EN contained in a location (for example the location “7”) of the configuration register CFGREG dedicated to this resource RES.

In another possibility, the configuration register CFGREG can be dedicated to a master device MSTR of the system-on-a-chip SOC.

In this case, the respective location, for example the location “7,” contains a second alert parameterization datum TAMP_CID.

The second alert parameterization datum TAMP_CID is used to activate or deactivate (for example when set to “1” or “o” respectively) the function of generating and communicating the alert signal TAMP_SGNL directly to the countermeasure circuit TAMP, by the protection circuit RISUP which blocks the transaction transmitted by the master device MSTR associated with this configuration register CFGREG.

In other words, the protection circuit RISUP of each resource RES is configured to generate or not the alert signal TAMP_SGNL in the case of a transaction addressed to the resource by the master device MSTR being blocked, according to the second alert parameterization datum TAMP_CID for this master device.

For example in practice, the protection circuit RISUP of each resource RES can know what master device transmitted the transaction via a master identification datum embedded in the transaction, for example the compartmentalization identifier CID.

Thus, according to two possibilities which are compatible and can be combined, a user can choose to generate the alert signal TAMP_SGNL if illegal access to a given resource is detected (with the alert parameterization datum TAMP_EN), and/or if illegal access by a given master device is detected (with the second alert parameterization datum TAMP_CID).

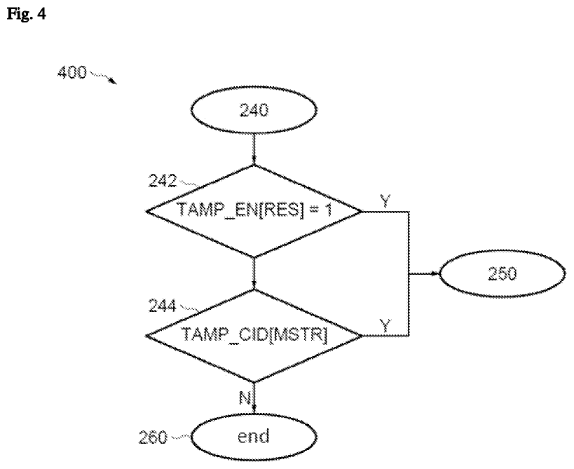

In this respect, reference is made to FIG. 4.

FIG. 4 illustrates an example implementation of a decision 400 taken by a protection circuit RISUP, in the event of a transaction (as described with reference to FIG. 2) being blocked 240, to generate or not the alert signal 250 (as described with reference to FIG. 2) depending on the alert parameterization data TAMP_EN, TAMP_CID contained in the set of configuration registers CFGREG.

In a step 242, a verification is carried out to check whether the resource RES to which the blocked transaction is addressed benefits from the protection of the countermeasure circuit TAMP, via the alert parameterization datum associated with this resource TAMP_EN[RES]. The protection circuit RISUP can access this datum contained in the configuration register

If yes, “y” then the alert signal is generated 250.

If no, “n” then a verification is carried out in a step 244 to check whether the master device MSTR that transmitted the blocked transaction benefits from the protection of the countermeasure circuit TAMP, via the second alert parameterization datum associated with this master device TAMP_CID[MSTR].

If yes, “y” then the alert signal is generated 250.

If no, “n” then the alert signal is not generated, and the implementation of the mechanism for activating the countermeasure circuit TAMP can be terminated in a step 260.

Optionally, after step 260, the resource isolation system can notify the master device MSTR that transmitted the illegal transaction, for example via the notification signal ILAC_BUS, or notify the trusted master device TDMSTR, for example via the interrupt signal ILAC_INTRPT.

Reference is made again to FIG. 3.

In this respect, on the one hand, in the case where the resource isolation system RIF is capable of generating the notification signal ILAC_BUS as mentioned above, the configuration register CFGREG dedicated to each resource RES can contain a location “8” intended to contain a notification parameterization datum ILAC_BUS_CFG. The notification parameterization datum ILAC_BUS_CFG is used to activate or deactivate the illegal access notification ILAC_BUS function via the error notification channel RREP of the interconnection bus BUS.

On the other hand, in the case where the resource isolation system RIF includes the central unit for managing illegal access IAC, as mentioned above, the configuration register CFGREG dedicated to each resource RES can advantageously contain a location “9” intended to contain an interrupt parameterization datum ILAC_INTRPT_CFG. The interrupt parameterization datum ILAC_INTRPT_CFG is used to activate or deactivate the function of the central unit for managing illegal access LAC generating interrupts ILAC_INTRPT to the trusted master device TDMSTR, in the case of an illegal access being detected, and respectively for each of the resources RES.

What is claimed is:

1. A system-on-a-chip comprising:
at least one slave resource;
a resource isolation system comprising, in a set of configuration registers, for each at least one slave resource, a first location for containing an alert parameterization datum;
a countermeasure circuit configured to limit an operation of the system-on-a-chip in response to potential anomalies; and
for each at least one slave resource, a protection circuit configured to:
block or transmit a transaction addressed to the at least one slave resource depending on access rights of the at least one slave resource and of the transaction; and
generate and directly communicate an alert signal to the countermeasure circuit in response to the transaction being blocked, according to the alert parameterization datum for the at least one slave resource.

2. The system-on-a-chip according to claim 1, further comprising a respective alert channel directly connecting the protection circuit of each at least one slave resource to the countermeasure circuit and dedicated to transmission of the alert signal.

3. The system-on-a-chip according to claim 2, further comprising:
a plurality of the at least one slave resource; and
a multiplexing element configured to group all of the alert channels respectively connected to each respective protection circuit into a single outgoing alert channel directly connected to the countermeasure circuit.

4. The system-on-a-chip according to claim 3, wherein the multiplexing element has an “OR gate”-type function for grouping the alert channels.

5. The system-on-a-chip according to claim 1, wherein:
the system-on-a-chip further comprises at least one master device configured to generate the transaction addressed to the at least one slave resource comprising a master identification datum;
the resource isolation system comprises, in the set of configuration registers, for each master device, a second location for containing a second alert parameterization datum; and
the protection circuit of each at least one slave resource is configured to generate, or not, the alert signal in response to the transaction addressed to the at least one slave resource by the master device being blocked, according to the second alert parameterization datum for the at least one master device.

6. The system-on-a-chip according to claim 1, wherein the protection circuit, for each at least one slave resource, is further configured to:
refrain from generating and communicating the alert signal to the countermeasure circuit in response to the transaction being blocked, according to the alert parameterization datum for the at least one slave resource.

7. A method for managing resource isolation of a system-on-a-chip comprising at least one slave resource, a resource isolation system, a countermeasure circuit configured to limit an operation of the system-on-a-chip in response to potential anomalies, and a protection circuit for each at least one slave resource, wherein the method comprises, for each at least one slave resource:
storing, by the resource isolation system in a set of configuration registers, for each at least one slave resource, an alert parameterization datum;
blocking, by the protection circuit, a first transaction addressed to the at least one slave resource, based on access rights of the at least one slave resource and of the first transaction; and
generating, by the protection circuit, an alert signal directly communicated to the countermeasure circuit in response to the first transaction being blocked, according to the alert parameterization datum for the at least one slave resource.

8. The method according to claim 7, further comprising:
blocking, by the protection circuit, a second transaction addressed to a second slave resource of the at least one slave resource, based on the access rights of the second slave resource and of the second transaction; and
refraining from generating a second alert signal in response to the second transaction being blocked, according to the alert parameterization datum for the second slave resource.

9. The method according to claim 7, further comprising transmitting the alert signal on a respective dedicated alert channel that directly connects the protection circuit of each at least one slave resource to the countermeasure circuit.

10. The method according to claim 9, wherein the system-on-a-chip includes a plurality of the at least one slave resource, and the method further comprises:
grouping all of the alert channels respectively connected to each respective protection circuits into a single outgoing alert channel directly connected to the countermeasure circuit.

11. The method according to claim 10, wherein the grouping comprises implementing an “OR gate”-type function for grouping the alert channels.

12. The method according to claim 11, wherein the method further comprises:
transmitting, by the protection circuit, a second transaction addressed to the at least one slave resource according to the alert parameterization datum for the at least one slave resource.

13. The method according to claim 12, wherein the system-on-a-chip further comprises at least one master device, and a second alert parameterization datum for each master device is contained in the set of configuration registers, and the method further comprises:
generating, by the at least one master device, the first transaction addressed to the at least one slave resource comprising an identification datum for the master device; and
generating the alert signal in response to the first transaction addressed to the at least one slave resource by the master device being blocked, according to the second alert parameterization datum for the at least one master device.

14. The method according to claim 13, wherein the method further comprises:
generating, by the at least one master device, a third transaction addressed to the at least one slave resource comprising the identification datum for the master device; and
transmitting, by the protection circuit, the third transaction addressed to the at least one slave resource, based on the second alert parameterization datum for the at least one master device.

15. The method according to claim 7, further comprising transmitting, by the protection circuit, a second transaction addressed to the at least one slave resource, based on the access rights of the at least one slave resource and of the second transaction.

16. A system-on-a-chip comprising:
a first slave resource;
a second slave resource;
a resource isolation system comprising, in a set of configuration registers, a first location for containing a first alert parameterization datum for the first slave resource;
a countermeasure circuit configured to limit an operation of the system-on-a-chip in response to potential anomalies;
a first protection circuit for the first slave resource, wherein the first protection circuit is configured to:
block or transmit a first transaction addressed to the first slave resource depending on first access rights of the first slave resource and of the first transaction; and
generate and directly communicate a first alert signal to the countermeasure circuit in response to the first transaction being blocked, according to the first alert parameterization datum for the first slave resource; and
a second protection circuit for the second slave resource, wherein the second protection circuit is configured to:
block or transmit a second transaction addressed to the second slave resource depending on second access rights of the second slave resource and of the second transaction; and
generate and directly communicate a second alert signal to the countermeasure circuit in response to the second transaction being blocked.

17. The system-on-a-chip according to claim 16, further comprising first and second alert channels directly connecting the first and second protection circuits respectively, to the countermeasure circuit and dedicated to transmission of the first and second alert signals, respectively.

18. The system-on-a-chip according to claim 17, further comprising:
a multiplexing element configured to group the first and second alert channels into a single outgoing alert channel directly connected to the countermeasure circuit.

19. The system-on-a-chip according to claim 16, wherein:
the resource isolation system comprises, in the set of configuration registers, a second location for containing a second alert parameterization datum for the second slave resource; and
the second protection circuit is configured to generate, or not, the second alert signal in response to the second transaction addressed to the second slave resource being blocked, according to the second alert parameterization datum for the second slave resource.

20. The system-on-a-chip according to claim 19, wherein:
the system-on-a-chip further comprises:
a first master device configured to generate the first transaction addressed to the first slave resource comprising a first master identification datum;
a second master device configured to generate the second transaction addressed to the second slave resource comprising a second master identification datum;
the resource isolation system comprises, in the set of configuration registers:
a third location for containing a third alert parameterization datum for the first master device; and
a fourth location for containing a fourth alert parameterization datum for the second master device;
the first protection circuit is configured to generate, or not, the first alert signal in response to the first transaction addressed to the first slave resource by the first master device being blocked, according to the third alert parameterization datum for the first master device; and
the second protection circuit is configured to generate, or not, the second alert signal in response to the second transaction addressed to the second slave resource by the second master device being blocked, according to the fourth alert parameterization datum for the second master device.
